(19) United States
(12) Patent Application Publication
(10) Pub. No.: US 2025/0269628 A1
(43) Pub. Date: Aug. 28, 2025

(54) GLAZING UNIT WITH DIFFUSE REFLECTION

(71) Applicant: SAINT-GOBAIN GLASS FRANCE, COURBEVOIE (FR)

(72) Inventors: Patrick GAYOUT, AUBERVILLIERS (FR); Ljiljana DURDEVIC, AUBERVILLIERS (FR); Laurent MAILLAUD, AUBERVILLIERS (FR)

(21) Appl. No.: 18/853,356

(22) PCT Filed: Apr. 4, 2023
(86) PCT No.: PCT/EP2023/058759

§ 371 Date: Oct. 1, 2024

(30) Foreign Application Priority Data
Apr. 4, 2022 (FR) 2203059

(51) Int. Cl. B32B 17/10; B32B 7/12; G02B 27/01; G02F 1/15

(52) U.S. Cl. CPC B32B 17/10036; B32B 7/12; B32B 17/10201; B32B 17/10513; B32B 17/10825; B32B 17/10743; B32B 17/10752; B32B 2605/00; G02B 27/0101; G02F 1/15

(57) ABSTRACT

A glazing unit includes a stack of layers between a lower substrate and a transparent upper substrate. The stack of layers includes two dielectric layers, a lower layer and an upper layer, the lower layer including a first layer made of an adhesive material, referred to as first adhesive layer, an intermediate layer made of a polymer material, in contact with the first adhesive layer, and having a refractive index that is substantially identical to that of the upper layer, a central layer in contact, in a textured interface, with each of the intermediate and upper layers, the central layer being configured so that the glazing has diffuse reflection properties.

### PRIOR ART

The present invention belongs to the general field of manufacturing glazing units. It relates more particularly to a glazing unit comprising a stack of layers between two glass sheets, so as to have diffuse reflection properties. It also relates to a method for manufacturing such a glazing unit, and also to a screen, a system and a projection method using such a glazing unit. The invention is advantageously used in a plurality of industrial applications, such as, in particular, in displaying information on a glazing unit for a building or for a vehicle.

Known glazing units include standard transparent glazing units, which give rise to specular transmission and reflection of radiation incident on the glazing unit, and translucent glazing units, which give rise to diffuse transmission and reflection of radiation incident on the glazing unit.

Usually, the reflection by a glazing unit is said to be diffuse when radiation incident on the glazing unit at a given angle of incidence is reflected by the glazing unit in a plurality of directions. Reflection by a glazing unit is said to be specular when radiation incident on the glazing unit at a given angle of incidence is reflected by the glazing unit at an angle of reflection equal to the angle of incidence. Similarly, transmission through a glazing unit is said to be specular when radiation incident on the glazing unit at a given angle of incidence is transmitted by the glazing unit at an angle of transmission equal to the angle of incidence.

One disadvantage of standard transparent glazing units is that they return sharp reflections, like mirrors, which is undesirable in certain applications. Thus, when a glazing unit is used for a building window or a display screen, it is preferable to limit the presence of reflections, which reduce visibility through the glazing unit. Sharp reflections on a glazing unit can also cause risks of glare, with ramifications in terms of safety, for example when vehicle headlights reflect on glazed building facades. This problem most particularly arises for glazed facades of airports. Indeed, it is essential to limit, as far as possible, the risk of glare for pilots approaching terminals.

Translucent glazing units have the advantage of not generating sharp reflections; however, they do not make it possible to see clearly through the glazing unit.

In order to overcome these disadvantages, it is known from the prior art, including document WO2012104547A1, to use a transparent layered element in the manufacture of a glazing unit, the aim being to impart diffuse reflection properties to said glazing unit while maintaining specular transmission properties.

This layered element may either be inserted between two transparent substrates, so as to form said glazing unit, or be added, for example by adhesive bonding, on a surface of an existing glazing unit. Each transparent substrate may for example consist of transparent polymer, transparent glass, transparent ceramic.

More particularly, said layered element comprises what is referred to as a “central” layer inserted between two outer layers, a lower layer and an upper layer, which consist of dielectric materials having substantially the same refractive index.

The contact (i.e. the contact surface) between the central layer and each of said outer layers is made according to what is referred to as a “textured” interface (so that each outer layer can be considered to be a textured layer). Conversely, each outer layer has, opposite to the textured interface that separates it from the central layer, a smooth surface.

In detail, the central layer is formed either by a single layer which is a dielectric layer having a refractive index different from that of the outer layers or a metal layer, or by a stack of layers which comprises at least one dielectric layer having a refractive index different from that of the outer layers or a metal layer. Each contact surface between two adjacent layers of the layered element, one of which is dielectric and the other metal, or both of which are dielectric layers having different refractive indices, is textured and parallel to the other textured contact surfaces between two adjacent layers, one of which is dielectric and the other metal, or both of which are dielectric layers having different refractive indices.

The production of such a layered element using an appropriate manufacturing method is not recalled here, it being understood that it is possible to consult, in particular, document WO2012104547A1 for more details. At the very least, it is recalled only that the central layer is deposited on the lower layer to conform to the textured surface of said lower layer (i.e. the single layer or each of the layers forming the central layer has a substantially uniform thickness over the entire extent of said textured surface).

For the entirety of the description given here, and unless indicated otherwise, the terms and expressions cited below refer respectively to:
dielectric material or layer: a material or a layer with low electrical conductivity of less than 100 S/m;
index: optical refractive index, measured at the wavelength of 550 nm;
substantially equal refractive indices of two dielectric materials: the absolute value of the difference between said refractive indices at 550 nm is less than or equal to 0.15, preferably less than 0.05, more preferably still less than 0.015;
different refractive indices of two dielectric materials: the absolute value of the difference between the refractive indices thereof at 550 nm is strictly greater than 0.15;
transparent element: element (material, substrate, etc.) through which there is specular transmission of radiation at least in the wavelength ranges useful for the intended application of the element. By way of example, when the element is used as a building or vehicle glazing unit, it is transparent at least in the visible wavelength range;
smooth surface/interface: surface/interface for which the surface/interface irregularities are of dimensions less than the wavelength of the radiation incident on the surface/interface, so that the radiation is not deflected by these surface/interface irregularities. The incident radiation is then transmitted and reflected specularly by the surface/interface;
textured surface/interface: surface/interface for which the surface/interface irregularities vary at a scale greater than the wavelength of the radiation incident on the surface/interface. In practice, a textured surface/interface has a plurality of patterns that are recessed or protruding relative to a general plane of said surface/said interface. Due to the presence of these irregularities, the incident radiation is then transmitted and reflected diffusely by the surface/interface.

Moreover, throughout the description and with regard to the composition of the central layer, a distinction is made between metal layers on the one hand, for which the value of the refractive index is unimportant, and the dielectric layers on the other hand, for which the difference in refractive index relative to that of the outer layers is to be taken into consideration.

FIG. 1 schematically illustrates an example of a glazing unit 1 of the prior art comprising a layered element 4 as mentioned above, and typically integrated into a projection screen.

As shown in FIG. 1, the glazing unit 1 comprises two transparent substrates, a lower substrate 2 and an upper substrate 3. More particularly, in this example, each of said substrates 2, 3 corresponds to a glass sheet.

The layered element 4 is formed, in particular, by a lower layer 5 made of PU (acronym for polyurethane) and an upper layer 6 made of PMMA (acronym for polymethyl methacrylate), said lower 5 and upper 6 layers respectively having substantially equal refractive indices. Furthermore, said lower layer 5 is in contact by means of a smooth interface (more precisely here a planar interface) with the lower substrate 2.

The layered element further comprises a central layer 7 in contact, by means of a textured interface, with each of said lower 5 and upper 6 layers. In other words, each of said lower 5 and upper 6 layers has a textured surface with which the central layer 7 is in contact (each of said lower 5 and upper 6 layers therefore corresponds to a textured layer).

In this example, and purely by way of illustration, said central layer 7 consists of a dielectric layer made of titanium oxide (TiO₂), the refractive index of which differs from those of the lower 5 and upper 6 layers.

In addition to the layered element 4, the glazing unit 1 also comprises a layer 8 which is made of PU and is in contact, by means of a smooth interface (more precisely here a planar interface), respectively with the upper layer 6 and the upper substrate 3. It should be noted that the refractive index of said layer 8 is unimportant, given the presence of said smooth interfaces. Ultimately, the assembly formed by the layered element 4 and said layer 8 corresponds to a stack of layers which characterizes the glazing unit 1.

Although widely deployed at the present time in information projection systems (examples: display screen integrated into a building, into street furniture, projection screen for personal use, etc.), a configuration such as that described with reference to FIG. 1 proves problematic. Indeed, it is very common to observe a phenomenon referred to as “waviness” through such a glazing unit, which tends to give a wavy visual impression of the layers placed between the transparent substrates of the glazing unit.

This phenomenon of waviness is explained by the fact that the manufacture of the glazing unit, via a conventional step of autoclave lamination (for example at a temperature of 95° C. and at a pressure of 6 bar), causes a relative movement between the lower 5 and upper 6 layers.

A plurality of defects result from this phenomenon of waviness, including:
defects in terms of the general visual appearance of the glazing unit. This is particularly true in the absence of projection, when the glazing unit is placed in front of a black background: the waves become perceptible;
defects in terms of the quality of the projected image. This is particularly true when the background of the projected image is light: the waves can make it difficult to interpret the image. The visual perception of these waves also increases with the angle of observation of the projected image, which further contributes to limiting access to the information intended to be transmitted by said image.

### Overview of the Invention

The aim of the present invention is to overcome all or some of the disadvantages of the prior art, in particular those disadvantages disclosed above, by proposing a solution that makes it possible to provide a glazing unit with diffuse reflection for which no phenomenon of waviness can be observed, such that said glazing has qualities, in terms of visual appearance and projected image, that are highly superior to those of the solutions of the prior art.

To this end, and according to a first aspect, the invention relates to a glazing unit comprising a stack of layers between two substrates, a lower substrate and a transparent upper substrate, each substrate comprising smooth surfaces opposite each other, said stack of layers comprising:
two dielectric layers, a lower layer and an upper layer, said lower layer comprising a first layer made of adhesive material, referred to as “first adhesive layer”, said lower and upper layers being respectively in contact, by means of a smooth interface, with the lower and upper substrates,
an intermediate layer made of a polymer material, in contact, by means of a smooth interface, with said first adhesive layer, and having a refractive index that is substantially identical, preferentially identical, to that of the upper layer,
a central layer in contact, by means of a textured interface, with each of said intermediate and upper layers, said central layer being formed either by a single layer which is a metal layer or a dielectric layer having a refractive index that is different from that of said intermediate and upper layers, or by a stack of layers which comprises a metal layer or at least one dielectric layer having a refractive index that is different from that of said intermediate and upper layers.

In particular embodiments, the adhesive material of the first adhesive layer is a transparent adhesive material and the first adhesive layer is referred to as “first OCA layer”.

In particular embodiments, said upper layer is made of transparent adhesive material or of polyurethane.

In particular embodiments, said intermediate layer is made of polymethyl methacrylate or polycarbonate.

In particular embodiments, the lower substrate is an absorbent and/or transparent glass.

In particular embodiments, the lower substrate is an opaque glass.

In particular embodiments, at least one of the surfaces of the lower substrate is covered at least in part with a dark enamel or a dark paint, for example a black enamel or a black paint.

In particular embodiments, the surface of the first adhesive layer at the interface with the intermediate layer is covered at least in part with a dark enamel or a dark paint, for example a black enamel or a black paint.

In particular embodiments, the lower layer consists of said first adhesive layer.

In particular embodiments, the adhesive material of the first adhesive layer is a transparent adhesive material and the first adhesive layer is referred to as “first OCA layer, the lower layer comprising:
a second layer made of transparent adhesive material, referred to as “second OCA layer”, and in contact, by means of a smooth interface, with the lower substrate,
what is referred to as an “intermediate” glass sheet in contact, by means of a smooth interface, with each of said first (41_OCA1) and second OCA layers, said intermediate sheet being an active film, for example an active electrochromic film.

According to a second aspect, the invention relates to a glazing unit comprising a stack of layers between two substrates, a lower substrate and a transparent upper substrate, each substrate comprising smooth surfaces opposite each other. Said stack of layers comprises:
two dielectric layers, a lower layer and an upper layer, said lower layer comprising a first layer made of transparent adhesive material, referred to as “first OCA layer”, said lower and upper layers being respectively in contact, by means of a smooth interface, with the lower and upper substrates,
an intermediate layer made of a polymer material, in contact, by means of a smooth interface, with said first OCA layer, and having a refractive index that is substantially identical, preferentially identical, to that of the upper layer,
a central layer in contact, by means of a textured interface, with each of said intermediate and upper layers, said central layer being formed either by a single layer which is a metal layer or a dielectric layer having a refractive index that is different from that of said intermediate and upper layers, or by a stack of layers which comprises a metal layer or at least one dielectric layer having a refractive index that is different from that of said intermediate and upper layers.

The glazing unit according to the invention is particularly advantageous in that the lower layer comprises said first OCA layer. Indeed, it is by virtue of this first OCA layer that the glazing unit according to the invention makes it possible to eliminate the phenomenon of waviness observed in the glazing units of the prior art.

This is because said first OCA layer has the particular feature of maintaining a constant thickness when the glazing unit is subjected, during its manufacture and as described in detail below, to a step of lamination by autoclave. These provisions therefore also make it possible to preserve the flatness of the intermediate layer during manufacture (at the interface between the intermediate layer and the first OCA layer), which ultimately eliminates any possibility of relative movement of the intermediate layer relative to the upper layer. Generally, any potential problem of deformation of these layers in the short or long term is avoided.

Compared to what the solutions known hitherto can propose, this results in performance qualities that are largely superior in terms of visual appearance and projected image.

In particular embodiments, the glazing unit may further comprise several of the following features, taken alone or in any technically feasible combinations.

In particular embodiments, said upper layer is made of transparent adhesive material (OCA) or of polyurethane.

The provisions according to which the upper layer is made of transparent adhesive material (OCA) make it possible to ultimately obtain a glazing unit comprising two OCA layers (said first OCA layer and said upper layer). The manufacture of such a glazing unit proves advantageous because it requires a reduced autoclave cycle time, but also an autoclave cycle that is less restrictive in terms of energy expended, since it can be implemented at a temperature below that used when there is only one OCA layer.

In particular embodiments, said intermediate layer is made of polymethyl methacrylate or polycarbonate.

In particular embodiments, the lower substrate is an absorbent and/or transparent glass.

In particular embodiments, the lower substrate is an opaque glass.

In particular embodiments, at least one of the surfaces of the lower substrate is covered at least in part with a dark enamel or a dark paint, for example an enamel or a black paint.

As is conventional, the color may be evaluated by virtue of the color coordinates L*, a* and b* calculated under illuminant D65 and with the CIE-1931 reference observer. The component L* defines the lightness, which ranges from the value 0 for black to the value 100 for white. Therefore, “dark” refers to any element having a lightness such that the L*value measured in reflection is less than 50.

In particular embodiments, the surface of the first OCA layer at the interface with the intermediate layer is covered at least in part with a dark enamel or a dark paint, for example a black enamel or a black paint.

In particular embodiments, the lower layer consists of said first OCA layer.

In particular embodiments, the lower layer comprises:
a second layer made of transparent adhesive material, referred to as “second OCA layer”, and in contact, by means of a smooth interface, with the lower substrate,
what is referred to as an “intermediate” glass sheet in contact, by means of a smooth interface, with each of said first and second OCA layers, said intermediate sheet being an active film, for example an electrochromic film.

According to a third aspect, the invention relates to a projection screen comprising a glazing unit according to the invention.

According to a fourth aspect, the invention relates to a projection system comprising a projection screen according to the invention and also a projector, the upper substrate being intended to be positioned facing said projector.

According to a fifth aspect, the invention relates to a projection method.

According to a sixth aspect, the invention relates to a use implemented by means of a projection system according to the invention.

According to a seventh aspect, the invention relates to a use of a glazing unit according to the invention as all or part of a glazing unit for a vehicle, for a building, for street furniture, for interior furnishings, for a display screen, for a Head Up Display system

According to an eighth aspect, the invention relates to a method for manufacturing a glazing unit, said method comprising the steps of:
obtaining two substrates, a lower substrate and a transparent upper substrate, each substrate comprising smooth surfaces opposite each other,
forming a stack of layers between the lower and upper substrates, said stack of layers being suitable for the manufacture of a glazing unit according to the invention,
autoclave lamination of the assembly formed by the lower and upper substrates and also by the stack of layers.

In particular embodiments, the method for manufacturing a glazing unit is a method for manufacturing a glazing unit according to the invention.

In particular embodiments, said forming step comprises:
depositing the lower layer on the lower substrate,
depositing the intermediate layer on the first adhesive layer,
texturing the intermediate layer at a surface opposite the smooth interface with the first adhesive layer,
conformally depositing the central layer on the textured surface of the intermediate layer,
depositing the upper layer on the upper substrate,
texturing the upper layer at a surface opposite the smooth interface with the upper substrate,
assembling the assembly formed by the lower substrate, the lower layer, the intermediate layer and the central layer with the assembly formed by the upper substrate and the upper layer, so that the central layer is also in contact with the textured surface of the upper layer.

In particular embodiments, the step of forming the stack of layers is implemented so as to manufacture a glazing unit according to the invention wherein the upper layer is made of transparent adhesive material.

In particular embodiments, the step of forming the stack of layers is implemented so as to manufacture a glazing unit according to the invention wherein the upper layer is made of transparent adhesive material, said forming step comprising:
depositing the lower layer on the lower substrate,
depositing the intermediate layer on the first OCA layer,
texturing the intermediate layer at a surface opposite the smooth interface with the first OCA layer,
conformally depositing the central layer on the textured surface of the intermediate layer,
depositing the upper layer on the upper substrate,
texturing the upper layer at a surface opposite the smooth interface with the upper substrate,
assembling the assembly formed by the lower substrate, the lower layer, the intermediate layer and the central layer with the assembly formed by the upper substrate and the upper layer, so that the central layer is also in contact with the textured surface of the upper layer.

In particular embodiments, the step of forming the stack of layers comprises:
adhering the lower layer to the lower substrate,
obtaining the intermediate layer comprising a smooth surface and an opposite textured surface,
conformally depositing the central layer on the textured surface of the intermediate layer, the deposited central layer comprising a first textured surface in contact with the textured surface of the intermediate layer and an opposite second textured surface,
arranging the upper layer on the upper substrate,
assembling the assembly formed by the lower layer and the lower substrate with the assembly formed by the intermediate layer and the central layer, so that the lower layer extends between the smooth surface of the intermediate layer and the lower substrate,
assembling the assembly formed by the lower substrate, the lower layer, the intermediate layer and the central layer with the assembly formed by the upper substrate and the upper layer, so that the central layer is also in contact with the upper layer.

In particular embodiments, the upper layer is made of a transparent adhesive material.

According to a ninth aspect, the invention relates to a method for producing a projection screen comprising the steps of the method for manufacturing a glazing unit according to the invention.

According to a tenth aspect, the invention relates to a method for producing a projection system comprising the steps of the method for producing the projection screen according to the invention, to obtain a projection screen, a step of providing a projector and a step of positioning the upper substrate facing said projector.

### BRIEF DESCRIPTION OF THE DRAWINGS

Other features and advantages of the present invention will emerge from the non-limiting description given below, with reference to the appended drawings that illustrate an exemplary embodiment thereof. In the Figures:

FIG. 1 schematically depicts an example of a glazing unit of the prior art comprising a layered element;

FIG. 2 schematically depicts a particular embodiment of a glazing unit according to the invention;

FIG. 3 schematically depicts another particular embodiment of a glazing unit according to the invention;

FIG. 4 schematically depicts another particular embodiment of a glazing unit according to the invention;

FIG. 5 schematically depicts another particular embodiment of a glazing unit according to the invention;

FIG. 6 schematically depicts another particular embodiment of a glazing unit according to the invention;

FIG. 7 schematically depicts a particular embodiment of a projection system according to the invention;

FIG. 8 depicts, in flowchart form, the main steps of a method for manufacturing a glazing unit according to the invention;

FIG. 9 depicts a particular embodiment of the method of FIG. 8;

FIG. 10 depicts an even more particular embodiment of the method of FIG. 9.

### DESCRIPTION OF EMBODIMENTS

Several particular embodiments of the invention are presented below. More specifically, particular embodiments of glazing units according to the invention are described first, followed by particular embodiments of methods for manufacturing such glazing units.

For the remainder of the description, it is considered, non-limitingly, that the glazing units in question are flat. It should however be noted that such provisions do not limit the invention; the invention may also apply to curved glazing units according to similar technical considerations that a person skilled in the art is able to implement.

Furthermore, throughout the description, a glazing unit according to the invention is considered to be placed horizontally, with a first face oriented downward defining a lower outer surface and a second face, opposite the first face, oriented upward defining an upper outer surface. The meaning of the expressions “above” and “below” is therefore to be considered with respect to this orientation. The terms “lower” and “upper” are also used here with reference to this positioning.

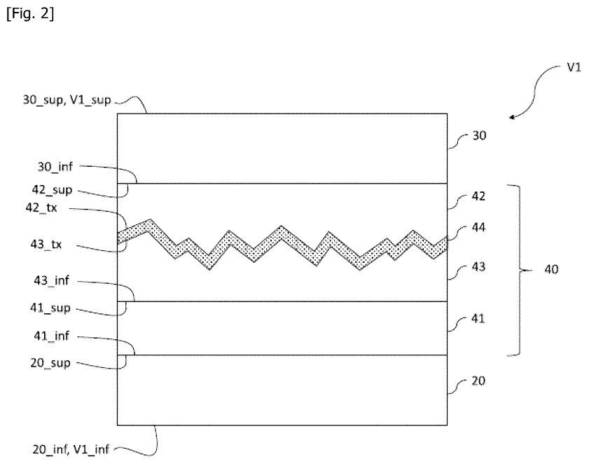

FIG. 2 schematically depicts a particular embodiment of a glazing unit V1 according to the invention.

In the embodiment of FIG. 2, the glazing unit V1 comprises a stack 40 of layers between two substrates:
a lower substrate 20 comprising a smooth lower surface 20_inf (this is the lower outer surface V1_inf of the glazing unit V1), and also a smooth upper surface 20_sup (this is the surface opposite said lower surface 20_inf),
a transparent upper substrate 30 comprising a smooth upper surface 30_sup (this is the upper outer surface V1_sup of the glazing unit V1), and also a smooth lower surface 30_inf (this is the surface opposite said upper surface 30_sup).

The lower surfaces 20_inf, 30_inf and upper surfaces 20_sup, 30_sup are substantially parallel to each other, preferably parallel to each other.

More particularly, in the embodiment described here, the upper substrate 30 is a transparent (mineral) glass. It should be noted that this glass may for example be purely transparent, or else both transparent and absorbent.

Examples of glass substrates that can be used directly as upper substrate 30 include in particular the glass substrates sold by Saint-Gobain Glass in the PLANICLEAR® or DIAMANT® ranges.

However, this does not preclude taking an upper substrate 30 made of polymer material into consideration. Examples of transparent polymers that are suitable for the upper substrate 30 include, in particular, polycarbonate and PMMA (acronym for “polymethyl methacrylate”).

In an identical manner, in the present embodiment, the lower substrate 20 is a transparent (mineral) glass. Moreover, the alternatives mentioned above regarding the upper substrate 30 (purely transparent, absorbent and transparent, made of polymer material) also apply for said lower substrate 20. Yet other embodiments, wherein an opaque lower substrate 20 is envisaged, are described in more detail below.

An example of a glass substrate that can be used directly as lower substrate 20 is the glass substrate sold by Saint-Gobain Glass in the PARSOL ULTRA GREY VENUS (VG10, VG20, VG40) range.

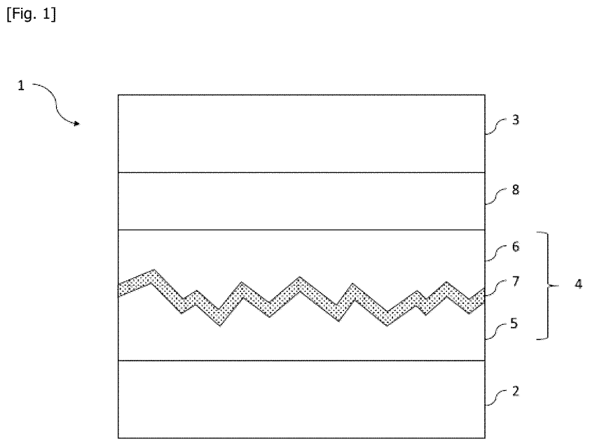

It should be noted that no limitation is attached to the dimensions of the lower substrate 20 and upper substrate 30. Thus, by way of example, said lower substrate 20 and upper substrate 30 may have (depending on the envisaged application) a thickness of between 1.1 mm and 12 mm, more particularly between 1.6 mm and 6 mm, even more particularly between 1.6 mm and 2.6 mm, or even for example substantially equal, or equal, to 2 mm (the thickness being measured vertically in the plane of FIG. 1).

The stack of layers 40 comprises two dielectric layers, a lower layer 41 and an upper layer 42.

As shown in FIG. 2, the lower layer 41 consists of a first layer made of transparent adhesive material, referred to as “first OCA layer” (the term “OCA” being the acronym for “Optical Clear Adhesive”). It should be noted that the transparent nature of said adhesive material does not preclude envisaging, according to more particular embodiments, said adhesive material also being absorbent.

Furthermore, said first OCA layer 41 is in contact, by means of a smooth interface, with the lower substrate 20. In other words, said first OCA layer 41 comprises a smooth lower surface 41_inf in contact with the upper surface 20_sup of the lower substrate 20. Said first OCA layer 41 also comprises a smooth upper surface 41_sup opposite said lower surface 41_inf.

In a manner known per se, the term “OCA” denotes a set of polymeric materials which, in the case of the present invention, are therefore used as transparent adhesives. Examples of polymeric materials which are suitable for said first OCA layer 41 include, in particular, polyurethane, preferably thermoset polyurethane, polyepoxide, polysiloxane, polyacrylate, polyester, etc.

Furthermore, said first OCA layer 41 has for example a thickness of between 200 μm and 250 μm. However, such thickness values are not limiting for the invention. More generally, no limitation is attached to the dimensions of said first OCA layer 41.

The upper layer 42 is made of polyurethane and is in contact, by means of a smooth interface, with the upper substrate 30. In other words, said upper layer 42 comprises a smooth upper surface 42_sup in contact with the lower surface 30_inf of the upper substrate 30. The thickness of said upper layer 42 is for example between 0.2 mm and 0.8 mm.

It should be noted that considering an upper layer 42 made of polyurethane merely constitutes a variant embodiment of the invention. Thus, there is nothing to preclude envisaging other variants, in particular an upper layer 42 made of transparent adhesive OCA material, or else of PVB (acronym for “polyvinyl butyral”), EVA (acronym for “ethylene-vinyl acetate”), etc. More particularly, PVB or EVA for the upper layer 42 are in particular suitable in the case where the glazing unit according to the invention comprises a dark enamel or a dark paint, and is intended for the manufacture of an opaque screen, as described in more detail later.

As shown in FIG. 2, the stack of layers 40 also comprises an intermediate layer 43 made of a polymer material, and in contact, by means of a smooth interface, with said first OCA layer 41. In other words, said intermediate layer 43 comprises a smooth lower surface 43_inf in contact with the smooth upper surface 41_sup of the first OCA layer. Furthermore, said intermediate layer 43 has a refractive index that is substantially identical, preferentially identical, to that of the upper layer 42.

In the embodiment described here, said intermediate layer 43 is made of PMMA and has for example a thickness of between 50 μm and 250 μm. However, there is nothing to preclude considering other materials for producing said intermediate layer 43, for example polycarbonate. Yet other examples of suitable materials for said intermediate layer 43 include, in particular, polyesters such as polyethylene terephthalate (PET), polybutylene terephthalate (PBT), polyethylene naphthalate (PEN); polyacrylates such as polymethyl methacrylate (PMMA); polycarbonate; polyurethane; polyamides; polyimides, cellulose triacetate (TAC), etc.

As shown in FIG. 2, the stack of layers 40 also comprises a central layer 44 in contact, by means of a textured interface, with each of said intermediate 43 and upper 42 layers. In other words, the intermediate layer 43 (respectively the upper layer 42) comprises a textured surface 43_tx opposite the lower surface 43_inf (respectively a textured surface 42_tx opposite the upper surface 42_sup) with which the central layer 44 is in contact.

Said central layer 44 is configured so that the glazing unit V1 has diffuse reflection properties. To this end, said central layer 44 is formed either by a single layer which is a metal layer or a dielectric layer having a refractive index that is different from that of said intermediate 43 and upper 42 layers, or by a stack of layers which comprises a metal layer or at least one dielectric layer having a refractive index that is different from that of said intermediate 43 and upper 42 layers.

Examples of central layers that can be inserted between the intermediate layer 43 and the upper layer 42 include thin dielectric layers, chosen from oxides, nitrides or halides of several transition metals, non-metals or alkaline earth metals, in particular layers of Si₃N₄, SnO₂, ZnO, ZrO₂, SnZnOₓ, AlN, NbO, NbN, TiO₂, SiO₂, Al₂O₃, MgF₂, AlF₃, or thin metal layers, in particular layers of silver, gold, copper, titanium, niobium, silicon, aluminum, nickel-chromium (NiCr) alloy, stainless steel, or alloys of these metals.

The patterns of the texture of each of the textured surfaces 42_tx, 43_tx (and also of the contact surfaces between layers when the central layer 44 is formed by a stack of layers) can be distributed randomly on the surface in question. As a variant, said patterns of the texture can be distributed periodically on the surface in question. These patterns may be, in particular, cones, pyramids, grooves, ribs, wavelets.

It should also be noted that said central layer 44 can be deposited on only a portion of the textured surface 43_tx of the intermediate layer 43.

The configuration details of the central layer 44 are not described further here since they have already been disclosed in numerous prior art documents. In this respect, it is possible to consult, for example, document WO2012104547A1 already mentioned previously.

A description will now be given of other particular embodiments of a glazing unit according to the invention, by virtue of the other figures. The reference numbers used in these other figures, which are identical to those introduced previously for FIG. 2, represent similar or identical elements.

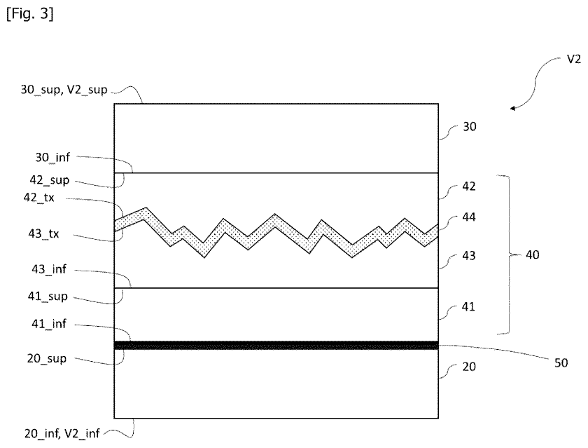

FIG. 3 schematically depicts another particular embodiment of a glazing unit V2 according to the invention, wherein the lower layer 41 also consists of an OCA layer, the lower substrate 20 being an opaque glass.

More particularly, in the embodiment of FIG. 3, the lower substrate 20 is a glass, the upper surface 20_sup of which is covered with a dark black enamel or a dark paint (example: a lacquer) 50, for example black or dark gray in color.

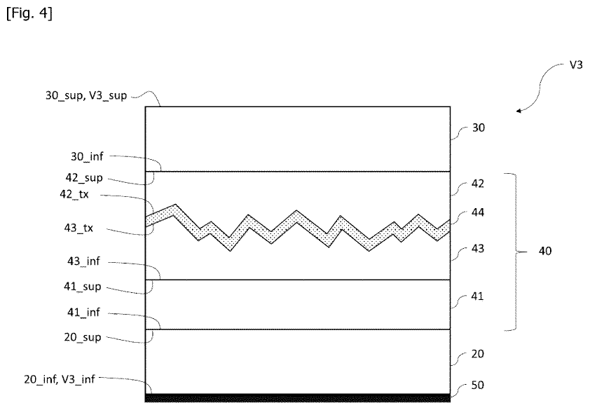

It should be noted that, in the example of FIG. 4, the dark enamel or the dark paint 50 completely covers the upper surface 20_sup. However, there is nothing to preclude envisaging other examples wherein the dark enamel or the dark paint 50 only partially covers said upper surface 20_sup, such provisions typically being advantageous in the field of automotive or transport glazing.

FIG. 4 schematically depicts another particular embodiment of a glazing unit V3 according to the invention.

In the embodiment of FIG. 4, the lower layer 41 also consists of an OCA layer and the lower substrate 20 is an opaque glass. However, the glazing unit V3 differs from the glazing unit V2 of FIG. 3 in that, in this case, the dark enamel or the dark paint 50 covers the lower surface 20_inf of said lower substrate 20.

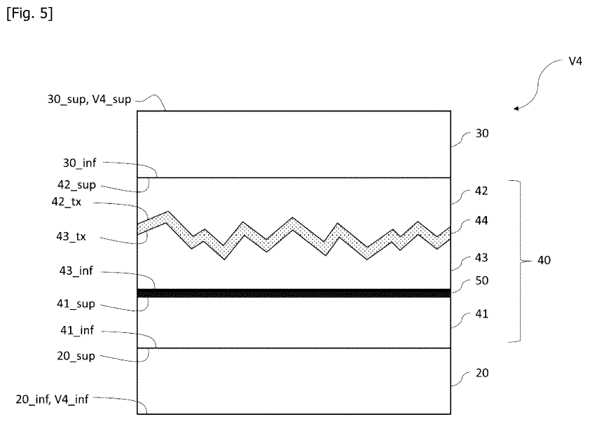

FIG. 5 schematically depicts another particular embodiment of a glazing unit V4 according to the invention.

In the embodiment of FIG. 5, the lower layer 41 also consists of an OCA layer. However, the glazing unit V4 differs from the glazing unit V2 of FIG. 3 and from the glazing unit V3 of FIG. 4 in that the upper surface 41_sup of the first OCA layer 41 is covered with a dark enamel or a dark paint 50 (in this case, the dark enamel or the dark paint 50 is contained in the stack of layers 40).

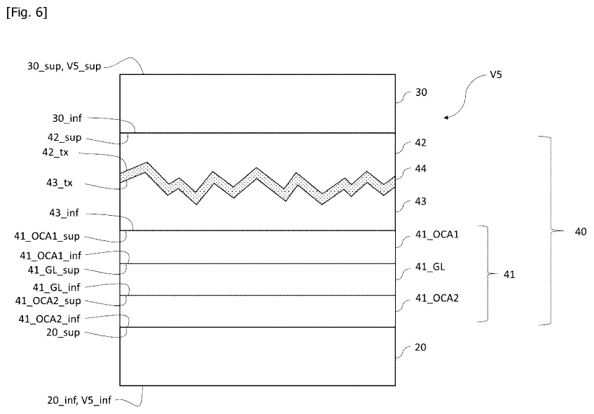

FIG. 6 schematically depicts another particular embodiment of a glazing unit V5 according to the invention.

In the embodiment of FIG. 6, the glazing unit V5 differs from the glazing unit V1 of FIG. 2 in that the lower layer 41 no longer only consists of an OCA layer, but here comprises:
a first OCA layer 41_OCA1 in contact, by means of a smooth interface, with the intermediate layer 43. In other words, the first OCA layer 41_OCA1 comprises a smooth upper surface 41_OCA1_sup in contact with the smooth lower surface 43_inf of the intermediate layer,
a second layer made of transparent adhesive material, referred to as “second OCA layer” 41_OCA2, and in contact, by means of a smooth interface, with the lower substrate 20. In other words, said second OCA layer 41_OCA2 comprises a smooth lower surface 41_OCA2_inf in contact with the upper surface 20_sup of the lower substrate 20.

Furthermore, in the embodiment of FIG. 6, the lower layer 41 of the glazing unit V6 also comprises what is referred to as an “intermediate” glass sheet 41_GL in contact, by means of a smooth interface, with each of said first and second OCA layers 41_OCA1, 41_OCA2. In other words, said intermediate sheet 41_GL comprises a smooth lower surface 41_GL_inf (respectively a smooth upper surface 41_GL_sup) in contact with the upper surface 41_OCA2_sup of the second layer OCA2 (respectively with the lower surface 41_OCA1_inf of the first layer OCA1).

Said intermediate sheet 41_GL is an active film, for example an active electrochromic film (for example an active electrochromic film based on anisotropic particles or liquid crystals to which dichroic dyes are added).

The invention has up to now been described with reference to the sole embodiments of FIGS. 2 to 6. It is however important to note that these embodiments do not restrict the invention, and there is nothing to preclude envisaging others. In particular, any technically effective combination of the embodiments of FIGS. 2 to 6 may be envisaged within the meaning of the present invention.

Furthermore, the invention does not only target a glazing unit as described above. Thus, according to other aspects, the invention also relates to a projection screen comprising such a glazing unit.

To this end, it may be noted that the implementation of such a screen is most particularly suited (but not limited) to embodiments wherein the lower substrate 20 is an absorbent glass, and also to embodiments wherein the lower substrate 20 is an opaque glass and/or the screen is a black screen due to the use of a dark paint or a dark enamel (the technical effect achieved is a reinforcement of the contrast of the projected image).

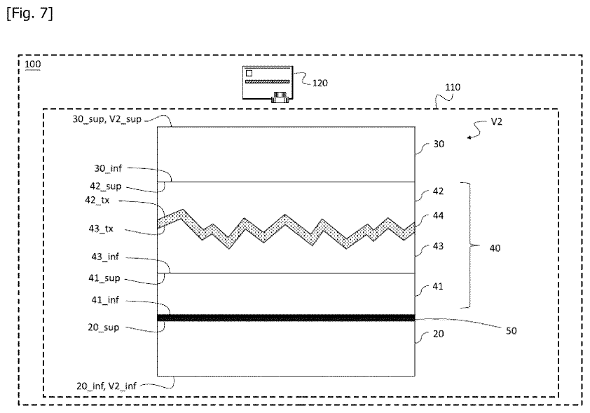

The invention also relates to a projection system 100. A particular embodiment of such a projection system 100 is depicted schematically, and entirely non-limitingly, by FIG. 7.

As illustrated in FIG. 7, said projection system 100 comprises a projection screen 110 according to the invention. More particularly, in the embodiment described here, the projection screen 110 comprises a glazing unit V2 such as that described with reference to FIG. 3.

The projection system 100 also comprises a projector 120, of a design known per se. The relative positions of the projector 120 and the projection screen 110 are such that the upper substrate 30 of the glazing unit integrated into the projection screen 110 is positioned facing the projector 120 (the images are therefore projected onto said upper substrate 30).

It should be noted that, within the meaning of the present invention, a projection system not only refers to an assembly wherein the screen and the projector are positioned relative to each other so as to enable the projection of images, but also to an assembly in the form of a kit, the elements of which that are the screen and the projector are to be positioned with the aim of enabling the projection of images.

Of course, a projection system 100 as described above can be used to project images, by implementing a projection method according to the invention (not shown in the figures).

However, the use of the glazing unit according to the invention is not limited to that of a projection screen. Thus, the glazing unit according to the invention is able to be used for all known applications of glazing units, such as for vehicles, buildings, street furniture, interior furnishings, lighting, display screens, etc.

The glazing unit according to the invention can also be used in a “Head Up Display” (HUD) system.

“HUD” refers here to a system that makes it possible to display information projected onto a glazing unit, generally the windshield of a vehicle, which information is reflected toward the driver or the observer. Such HUD systems are in particular useful in aircraft cockpits, trains, but also at the present time in privately-owned motor vehicles (cars, trucks, etc.). These systems make it possible to give information to the driver of the vehicle without the driver looking away from the field of view in front of the vehicle, making it possible to greatly increase safety.

Embodiments of a method for manufacturing a glazing unit according to the invention will now be described.

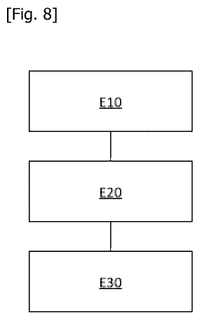

FIG. 8 depicts, in flowchart form, the main steps of said manufacturing method.

As shown in FIG. 8, the manufacturing method comprises a step E10 of obtaining lower 20 and upper 30 substrates.

The manufacturing method further comprises a step E20 of forming the stack of layers 40 between the lower 20 and upper 30 substrates.

Once the assembly formed by the lower 20 and upper 30 substrates and also by the stack of layers 40 is obtained, the manufacturing method comprises a step E30 of autoclave lamination of said assembly.

By way of non-limiting example, when the upper layer 42 is made of polyurethane, said autoclave cycle is carried out under temperature conditions of between 80° C. and 100° C., preferentially between 85° C. and 95° C., and under pressure conditions of between 6 and 10 bar, in particular substantially equal, or equal, to 6 bar.

According to another example, when the upper layer 42 is made of transparent adhesive OCA material, said autoclave cycle is carried out under temperature conditions of between 30° C. and 50° C., and under pressure conditions substantially equal, or equal, to 5 bar.

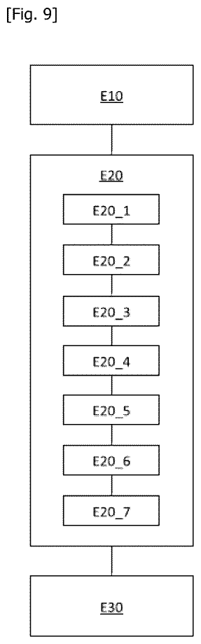

FIG. 9 depicts, in flowchart form, a particular embodiment of the method of FIG. 8.

More particularly, in the embodiment of FIG. 9, the glazing unit manufactured is a glazing unit wherein the upper layer 42 is made of transparent adhesive OCA material.

As shown in FIG. 9, the forming step E20 comprises, in the particular embodiment described here:
depositing E20_1 the lower layer 41 on the lower substrate 20, so as to be in contact, by means of a smooth interface, with said lower substrate 20,
depositing E20_2 the intermediate layer 43 on the first layer 41_OCA1, so as to be in contact, by means of a smooth interface, with said first layer 41_OCA1,
texturing E20_3 the intermediate layer 43 at the surface opposite the smooth interface with the first OCA layer 41_OCA1, so as to form the textured surface 43_tx,
conformally depositing E20_4 the central layer 44 on the textured surface 43_tx of the intermediate layer 43,
depositing E20_5 the upper layer 42 on the upper substrate 30, so as to be in contact, by means of a smooth interface, with said upper substrate 30,
texturing E20_6 the upper layer 42 at a surface opposite the smooth interface with the upper substrate 30, so as to form the textured surface 42_tx (of course, the textured surface 42_tx is complementary to the textured surface of the central layer 44, so as to be able to be superimposed),
assembling E20_7 the assembly formed by the lower substrate 20, the lower layer 41, the intermediate layer 43 and the central layer 44 with the assembly formed by the upper substrate 30 and the upper layer 42, so that the central layer 44 is also in contact with the textured surface 42_tx of the upper layer 42.

It should be noted that, in a manner known per se, the texturing of a surface may be obtained by any known texturing method, for example by embossing the surface of the layer heated beforehand to a temperature at which it can be deformed, in particular by lamination using a roller, the surface of which has texturing complementary to the texturing to be formed on the layer; by abrasion by means of particles or abrasive surfaces, in particular by sand blasting; by chemical treatment, in particular treatment with acid in the case of a glass substrate; by molding, in particular injection molding in the case of a substrate made of thermoplastic polymer; or by etching.

The conformal deposition of the central layer 44, whether it is a single layer or formed by a stack of several layers, is for example carried out under vacuum, by magnetron sputtering.

It is of course possible to envisage yet more particular embodiments of the manufacturing method, depending on the composition, in terms of layers, of the glazing unit manufactured.

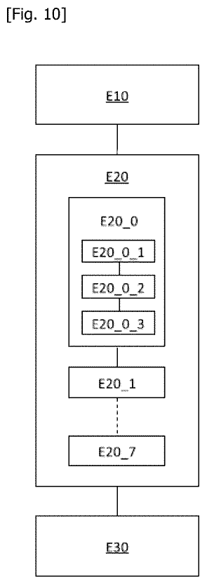

Thus, if the manufactured glazing unit is of the type in FIG. 6, the step E20 of forming the stack of layers 40 can also comprise, before the deposition E20_1 of the lower layer 41 and as is shown entirely non-limitingly in FIG. 10, a formation E20_0 of said lower layer 41 comprising:
depositing E20_0_1 the second OCA layer 41_OCA2 on the lower substrate 20, so as to be in contact, by means of a smooth interface, with said lower substrate 20,
depositing E20_0_2 the intermediate glass sheet 41_GL on the second OCA layer 41_OCA2, so as to be in contact, by means of a smooth interface, with said second OCA layer 41_OCA2,
depositing E20_0_3 the first OCA layer 41_OCA1 on the intermediate glass sheet 41_GL, so as to be in contact, by means of a smooth interface, with said intermediate glass sheet 41_GL.

Furthermore, if a dark enamel or a dark paint is used in accordance with one of the embodiments described above, the manufacturing method then comprises a step of applying said dark enamel or said dark paint.

The first adhesive layer of the first lower layer 41 is adhesive before the step of autoclave lamination.

According to one exemplary embodiment, the first adhesive layer is an adhesive film.

The second adhesive layer of the first lower layer 41 is adhesive before the step of autoclave lamination.

According to one exemplary embodiment, the second adhesive layer is an adhesive film.

The lower surface 41_inf of the lower layer 41 is an adhesive surface and the upper surface 41_sup of the lower layer 41 is an adhesive surface.

The lower surface 41_inf and the upper surface 41_sup of the lower layer 41 are adhesive before the autoclave lamination step.

As a variant, the step of forming the step of forming the stack of layers comprises:
adhering the lower layer 41 to the lower substrate 20,
obtaining the intermediate layer 43 comprising a smooth surface and an opposite textured surface,
conformally depositing the central layer 44 on the textured surface of the intermediate layer 43, the deposited central layer 44 comprising a first textured surface in contact with the textured surface of the intermediate layer 43 and an opposite second textured surface,
arranging the upper layer 42 on the upper substrate 30,
assembling the assembly formed by the lower layer 41 and the lower substrate 20 with the assembly formed by the intermediate layer 43 and the central layer 44, so that the lower layer 41 extends between the smooth surface of the intermediate layer 43 and the lower substrate 20,
assembling the assembly formed by the lower substrate 20, the lower layer 41, the intermediate layer 43 and the central layer 44 with the assembly formed by the upper substrate 30 and the upper layer 42, so that the central layer 44 is also in contact with the upper layer 42.

For example, the adhesion of the lower layer 41 to the smooth surface of the intermediate layer 43 and to the lower substrate 20 is carried out by pressing the lower layer 41 onto the intermediate layer 43 and the lower substrate 20.

During the autoclave lamination step, the upper layer 42 is textured at a surface opposite the smooth interface with the upper substrate 30 so as to form the textured surface 42_tx.

In particular, during the step of autoclave lamination the lower layer 41 remains flat.

1. A glazing unit comprising a stack of layers between two substrates, which include a lower substrate and a transparent upper substrate, each substrate comprising smooth surfaces opposite each other, said stack of layers comprising:
two dielectric layers, which include a lower layer and an upper layer, said lower layer comprising a first adhesive layer made of adhesive material, referred to as “first adhesive layer”, said lower and upper layers being respectively in contact, by means of a smooth interface, with the lower and upper substrates,
an intermediate layer made of a polymer material, in contact, by means of a smooth interface, with said first adhesive layer, and having a refractive index that is substantially identical, preferentially identical, to that of the upper layer,
a central layer in contact, by means of a textured interface, with each of said intermediate and upper layers, said central layer being formed either by a single layer which is a metal layer or a dielectric layer having a refractive index that is different from that of said intermediate and upper layers, or by a stack of layers which comprises a metal layer or at least one dielectric layer having a refractive index that is different from that of said intermediate and upper layers.

2. The glazing unit according to claim 1, wherein the adhesive material of the first adhesive layer is a transparent adhesive material and the first adhesive layer is a “first OCA layer”.

3. The glazing unit according to claim 1, wherein said upper layer is made of transparent adhesive material or polyurethane.

4. The glazing unit according to claim 1, wherein said intermediate layer is made of polymethyl methacrylate or of polycarbonate.

5. The glazing unit according to claim 1, wherein the lower substrate is an absorbent and/or transparent glass.

6. The glazing unit according to claim 1, wherein the lower substrate is an opaque glass.

7. The glazing unit according to claim 6, wherein at least one of the surfaces of the lower substrate is covered at least in part with a dark enamel or a dark paint, for example a black enamel or a black paint.

8. The glazing unit according to claim 1, wherein the surface of the first adhesive layer at the interface with the intermediate layer is covered at least in part with a dark enamel or a dark paint, for example a black enamel or a black paint.

9. The glazing unit according to claim 1, wherein the lower layer consists of said first adhesive layer.

10. The glazing unit according to claim 2, wherein the lower layer comprises:
a second OCA layer made of transparent adhesive material, referred to, and in contact, by means of a smooth interface, with the lower substrate,
an “intermediate” glass sheet in contact, by means of a smooth interface, with each of said first and second OCA layers, said intermediate sheet being an active film.

11. A projection screen comprising a glazing unit according to claim 1.

12. A projection system comprising a projection screen according to claim 11 and also a projector, the upper substrate being intended to be positioned facing said projector.

13. A projection method comprising projecting an image implemented by means of a with the projection system according to claim 12.

14. A use of method comprising providing a glazing unit according to claim 1 as all or part of a glazing unit for a vehicle, for a building, for street furniture, for interior furnishings, for a display screen, for a Head Up Display system.

15. A method for manufacturing a glazing unit according to claim 1, said method comprising the steps of:
obtaining the two substrates, which include the lower substrate and the transparent upper substrate, each substrate comprising smooth surfaces opposite each other,
forming the stack of layers between the lower and upper substrates, said stack of layers being suitable for the manufacture of said glazing unit,
autoclave lamination of an assembly formed by the lower and upper substrates and also by the stack of layers.

16. The method according to claim 15, wherein said forming-step comprises:
depositing the lower layer on the lower substrate,
depositing the intermediate layer on the first adhesive layer,
texturing the intermediate layer at a surface opposite the smooth interface with the first adhesive layer,
conformally depositing the central layer on the textured surface of the intermediate layer,
depositing the upper layer on the upper substrate,
texturing the upper layer at a surface opposite the smooth interface with the upper substrate,
assembling the assembly formed by the lower substrate, the lower layer, the intermediate layer and the central layer with the assembly formed by the upper substrate and the upper layer, so that the central layer is also in contact with the textured surface of the upper layer.

17. The method according to claim 15, wherein said forming-step comprises:
adhering the lower layer to the lower substrate,
obtaining the intermediate layer comprising a smooth surface and an opposite textured surface,
conformally depositing the central layer on the textured surface of the intermediate layer, the deposited central layer comprising a first textured surface in contact with the textured surface of the intermediate layer and an opposite second textured surface,
arranging the upper layer on the upper substrate,
assembling the assembly formed by the lower layer and the lower substrate with the assembly formed by the intermediate layer and the central layer, so that the lower layer extends between the smooth surface of the intermediate layer and the lower substrate
assembling the assembly formed by the lower substrate, the lower layer, the intermediate layer and the central layer with the assembly formed by the upper substrate and the upper layer, so that the central layer is also in contact with the upper layer.

18. The method according to claim 16, wherein the upper layer is made of a transparent adhesive material.

19. A method for producing a projection screen comprising performing the steps of the method for manufacturing the glazing unit according to claim 15.

20. A method for producing a projection system comprising the steps of the method for producing the projection screen according to claim 19 to obtain a projection screen, a step of providing a projector and a step of positioning the upper substrate facing said projector.
